(19) United States
(12) Patent Application Publication
(10) Pub. No.: US 2001/0019380 A1
(43) Pub. Date: Sep. 6, 2001

(54) Lighting unit and liquid crystal display utilizing the same

(76) Inventor: Takayuki Ishihara, Kyoto (JP)

Correspondence Address: Michael D. Bednarek, SHAW PITTMAN, 1650 Tysons Boulevard, McLean, VA, 22102-4859, US

(21) Appl. No.: 09/796,527

(22) Filed: Mar. 2, 2001

(30) Foreign Application Priority Data
Mar. 3, 2000 (JP) 2000-58155

(51) Int. Cl. G02F 1/1335

(52) U.S. Cl. 349/65

(57) ABSTRACT

A lighting unit includes a light guide and a light source. The light guide is provided with a light inlet section, while the light source is provided with a light emitting surface facing the light inlet section. The light inlet section is formed with a plurality of light refracting surfaces inclined relative to the light emitting surface of the light source. Due to the light refracting surfaces, light emitted from the light source is properly distributed through the light guide.

### BACKGROUND OF THE INVENTION

1. Field of the Invention

The present invention relates to a lighting unit including a light guide and a point light source. The invention also relates to a liquid crystal display utilizing such a lighting unit.

2. Description of the Related Art

Conventionally, liquid crystal displays (LCDs) can be classified into two types depending upon the arrangement of the lighting system. One is a backlight type where the lighting unit is arranged behind the LCD panel, and the other is a front light type where the lighting unit is arranged in front of the LCD panel.

FIGS. 10A-10B and 11A-11B show conventional lighting units 8A and 8B used for backlight type LCDs. The lighting unit 8A (FIGS. 10A-10B) includes a rectangular light guide 81A and a point light source 80A. The light guide 81A has a flat light inlet surface 81a facing the light emitting surface 80a of the light source 80A. Likewise, the other lighting unit 8B (FIGS. 11A-11B) includes a generally rectangular light guide 81B and a point light source 80B. The light inlet surface 81b of the light guide 81B is not flat but semicircular.

In the first lighting unit 8A, the light emitted from the light source 80A may fail to propagate enough in the sideways direction Ds since the light inlet surface 81a is simply flat. Thus, additional light sources 80B maybe needed for obtaining uniform illumination brightness. Disadvantageously, the provision of the additional light sources may cause an increase in fabrication cost. Also, the use of a greater number of light sources will lead to increased power consumption.

In the second lighting unit 8B, on the other hand, the light emitted from the light source 80B can propagate more efficiently in the Ds direction due to the semicircular light inlet surface 81b. However, this arcuate configuration may allow an unduly large space to be present between the light inlet surface 81b and the light emitting surface 80b of the light source 80B. Due to this, as shown in FIG. 11B, part of the light emitted from the light source 80B may fail to enter the light guide 8B, which is a waste of power.

### SUMMARY OF THE INVENTION

The present invention has been proposed under the circumstances described above. It is, therefore, an object of the present invention to provide a lighting unit capable of properly distributing light in a light guide with reduced power consumption.

Another object of the present invention is to provide a liquid crystal display incorporating such a lighting unit.

According to a first aspect of the present invention, there is provided a lighting unit including: a light guide provided with a light inlet section; and a light source provided with a light emitting surface facing the light inlet section. The light guide is provided, at the light inlet section, with a plurality of light refracting surfaces inclined relative to the light emitting surface so that light from the light source is distributed in the light guide.

In a preferred embodiment, the light refracting surfaces include a plurality of first slopes which are symmetrical with respect to a predetermined reference line, wherein the first slopes are steeper relative to the light emitting surface as they are farther from the reference line.

Further, the light refracting surfaces may include a plurality of second slopes which are symmetrical with respect to the reference line, wherein the second slopes are gentler relative to the light emitting surface as they are farther from the reference line.

In another preferred embodiment, the light refracting surfaces may include a plurality of additional slopes different from the first and the second slopes, wherein the additional slopes, together with the first and the second slopes, define a plurality of pyramids.

Preferably, the pyramids may be arranged in rows and columns. Also, the pyramids maybe provided with apexes lying on the same plane parallel to the light emitting surface.

Preferably, the light inlet section may be provided with a light refracting wall surface adjacent to the pyramids. Additionally, the light inlet section may be provided with a flat surface which is arranged adjacent to the pyramids and generally parallel to the light emitting surface.

Preferably, the light guide maybe provided with a main portion covering an object to be illuminated and with an elongated auxiliary portion connected to the main portion, wherein the light refracting surfaces are provided at the auxiliary portion.

Preferably, the auxiliary portion may be formed with a recess for accommodating the light source.

Preferably, the main portion may include a generally flat rear surface and a front surface opposite to the rear surface, wherein the auxiliary portion projects beyond the rear surface of the main portion away from the front surface of the main portion.

Preferably, the recess may be open only in the projecting direction of the auxiliary portion.

Preferably, the light guide may be provided with a reflective surface for directing light from the auxiliary portion to the main portion.

According to a second aspect of the present invention, there is provided a liquid crystal display including: a liquid crystal display panel; a light guide provided with a light inlet section; and a light source provided with a light emitting surface facing the light inlet section. The light guide is provided, at the light inlet section, with a plurality of light refracting surfaces inclined relative to the light emitting surface so that light from the light source is distributed in the light guide.

Other features and advantages of the present invention will become apparent from the detailed description given below with reference to the accompanying drawings.

### BRIEF DESCRIPTION OF THE DRAWINGS FIG. 1 is a sectional view showing a liquid crystal display according to a first embodiment of the present invention;

FIG. 2 is an exploded view showing transparent electrodes formed on the glass plates of the LCD;

FIG. 3 is a perspective view showing the principal parts of the LCD;

FIG. 4 is an enlarged view showing the light refracting means of the LCD;

FIG. 5 is an enlarged view showing the same light refracting means from a different angle;

FIG. 6 is a perspective view showing the light refracting means;

FIG. 7 is a sectional view showing an example of a modified recess to accommodate the light source;

FIG. 8 is a perspective view showing the principal parts of a liquid crystal display according to a second embodiment of the present invention;

FIG. 9 is a perspective view showing the principal parts of a liquid crystal display according to a third embodiment of the present invention;

FIGS. 10A-10B show a conventional backlighting unit; and

FIGS. 11A-11B show another conventional backlighting unit.

### DETAILED DESCRIPTION OF THE PREFERRED EMBODIMENTS

The preferred embodiments of the present invention will be described below with reference to the accompanying drawings.

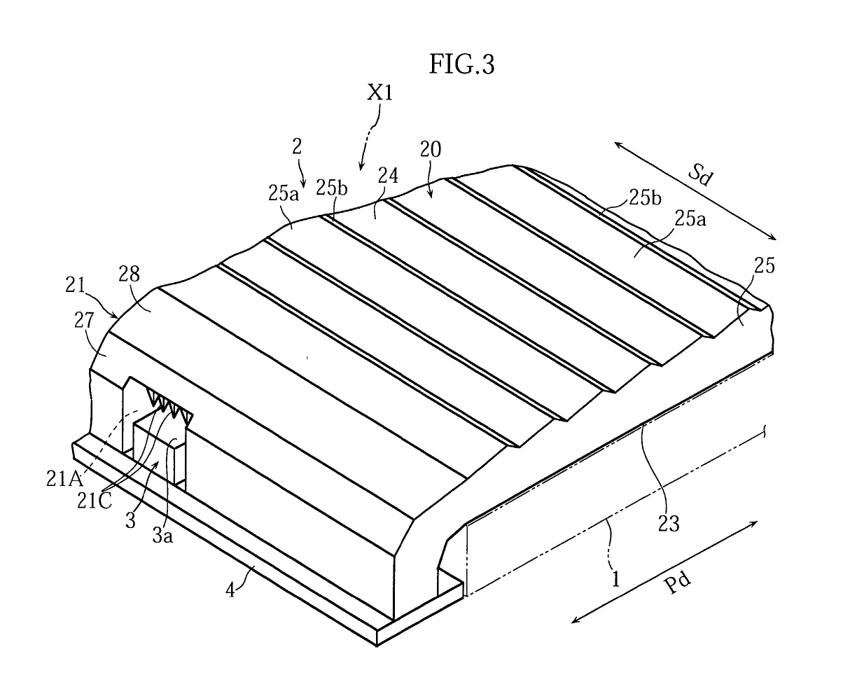

Reference is first made to FIGS. 1-6 illustrating a liquid crystal display (LCD) X1 according to a first embodiment of the present invention. As best shown in FIGS. 1 and 3, the LCD X1 includes an LCD panel 1, a light guide 2, and a point light source 3. The light guide 2 covers the front surface of the panel 1. The light source 3 is mounted on a substrate 4, and may include a light-emitting diode (LED).

The LCD panel 1 has a conventionally known structure. Specifically, the panel 1 is provided with first and second transparent glass plates 10a-10b, between which liquid crystal 12 is contained by a sealing member 11. A first polarizer 13a is arranged on the front side of the first glass plate 10a, while a second polarizer 13b, together with a mirror 14, is arranged on the rear side of the second glass plate 10b.

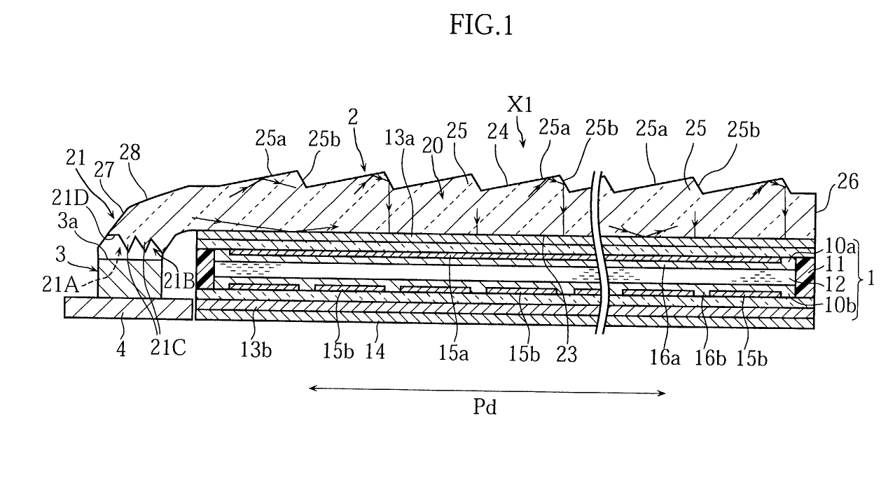

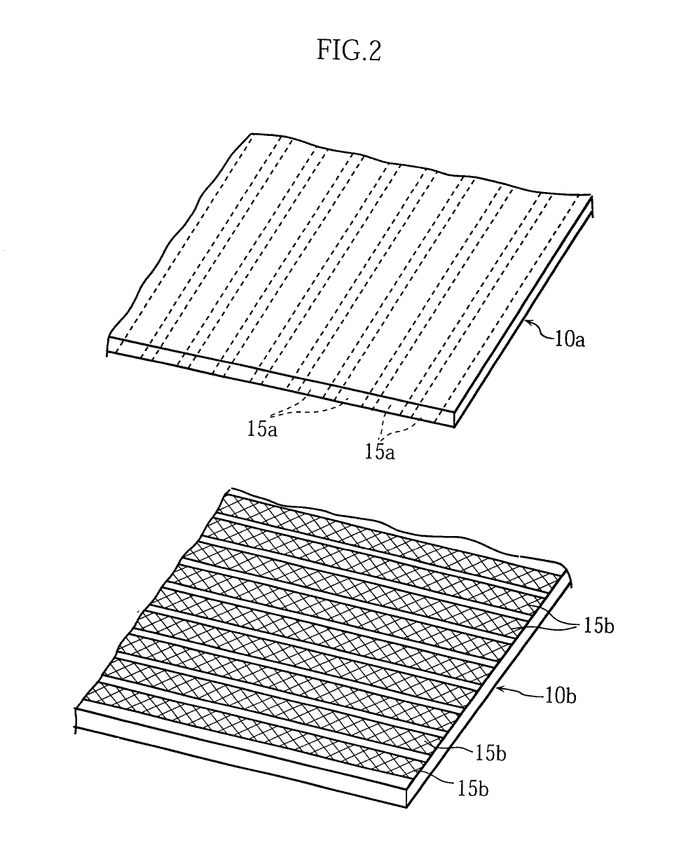

As shown in FIG. 2, the rear surface of the first glass plate 10a is formed with a plurality of elongated, transparent electrodes 15a (first electrodes). Likewise, the front surface of the second glass plate 10b is formed with a plurality of elongated, transparent electrodes 15b (second electrodes). Each of the first electrodes 15a extends perpendicularly to the second electrodes 15b. The intersection of the first electrodes 15a and the second electrodes 15b provides pixels. The first electrodes 15a are covered with a first alignment layer 16a, while the second electrodes 15b are covered with a second alignment layer 16b. The alignment layers 16a-16b give the required twist to the molecules of the liquid crystal 12.

The light guide 2, as shown in FIGS. 1 and 3, includes a main light guiding body 20 and a light inlet portion 21 formed integral with the main body 20 by a molding technique. As seen from FIG. 1, the inlet portion 21 extends rearward (downward in the figure) beyond the rear surface 23 of the main body 20. The light guide 2 may be made of a transparent resin material such as PMMA (polymethylmethacrylate).

The main body 20 has a flat rear surface 23 and an uneven front surface 24. The front surface 24 is formed with a plurality of projections 25 having a triangular cross section defined by first and second inclined surfaces 25a, 25b. As shown in FIG. 3, the projections 25 are arranged at predetermined pitches in the primary direction Pd. Each projection 25 extends in the secondary direction Sd perpendicular to the primary direction Pd.

The light inlet portion 21, as shown in FIG. 3, is formed with first and second reflective surfaces 27, 28 each of which extends in the secondary direction Sd. The inlet portion 21 is also formed with a recess 21A, at its longitudinal center, to accommodate the light source 3.

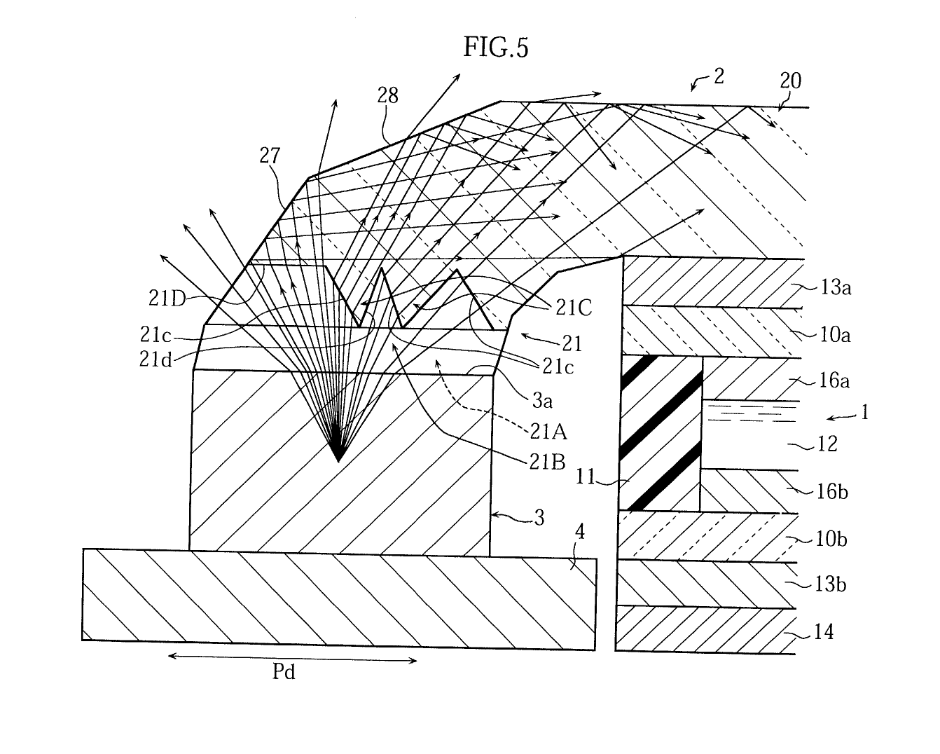

As seen from FIG. 5, the reflective surfaces 27 and 28 of the inlet portion 21 are inclined at predetermined angles relative to the normal direction of the light emitting surface 3a of the light source 3. The light emitted from the light source 3 is totally reflected on these surfaces toward the main body 20.

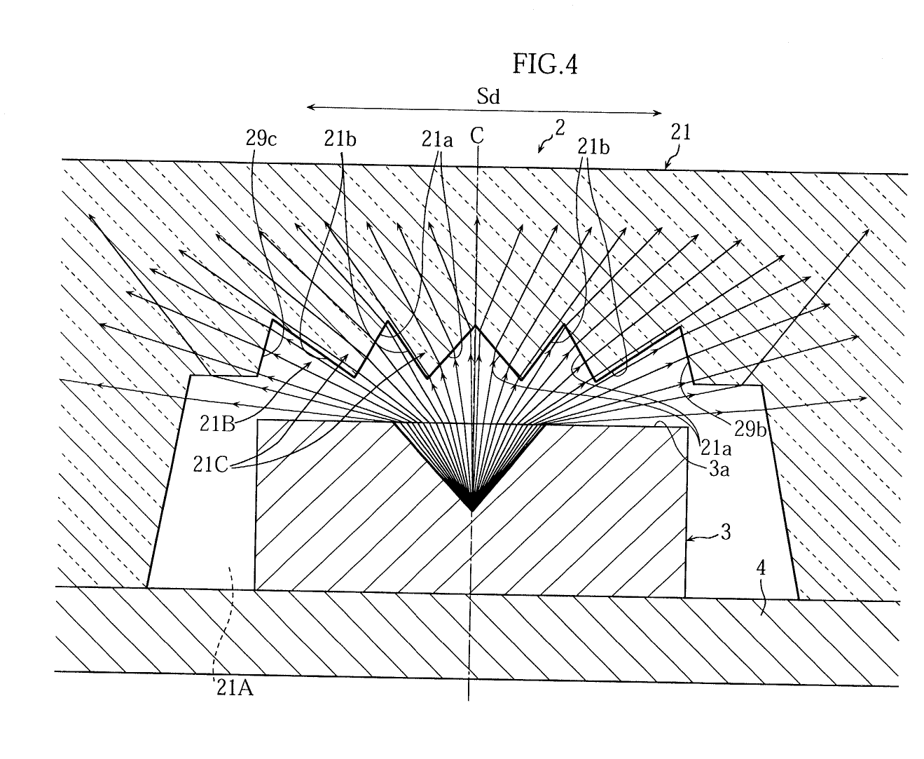

As shown in FIGS. 4-6, a plurality of downward projections 21C, together with other elements, are formed in a front region 21B of the recess 21A. Specifically, as best shown in FIG. 6, the front region 21B is provided with first to third wall surfaces 29a-29c and a flat surface 21D, which surround eight quadrangular pyramids 21C (two in the Pd direction and four in the Sd direction). Each of the quadrangular pyramids 21C has first to fourth triangular surfaces 21a-21d.

As seen from FIG. 4, the eight pyramids 21C are symmetrical with respect to the center line C. The first triangular surfaces 21a of the respective pyramids 21C slope at smaller angles as they are closer to the center line C. On the other hand, the second triangular surfaces 21b of the respective pyramids 21C slope at greater angles as they are closer to the center line C. The second and the third wall surfaces 29b, 29c slope at greater angles than the first triangular surfaces 21a of the adjacent pyramids 21C.

As seen from FIGS. 4 and 5, each of the pyramids 21C has an apex pointing to the light source 3. The apexes of the respective pyramids 21C lie on the same imaginary plane (not shown) parallel to the light emitting surface 3a of the light source 3.

With the above arrangements, the light emitted from the light source 3 mainly enters either one of the first triangular surfaces 21a, the third triangular surfaces 21c and the flat surface 21D. As shown in FIG. 4, upon meeting the first triangular surfaces 21a, the light is refracted sideways, to propagate through the light inlet portion 21 in the Sd direction. As shown in FIG. 5, upon meeting the third triangular surfaces 21c, the light is refracted to the right, and introduced into the main body 20 directly or after being reflected on the second reflective surface 28. It should be appreciated here that, due to the refraction at the third triangular surfaces 21c, the incident angle of the light striking upon the reflective surface 28 or the front surface of the main body 20 can be rendered great enough, whereby the light is totally reflected. Upon meeting the flat surface 21D, the light is hardly refracted. Thus, the light travels straight to the first reflective surface 27, to be reflected toward the main body 20.

According to the present invention, the quadrangular pyramids 21C may be replaced by triangular pyramids, cylindrical projections, etc.

As shown in FIG. 1, the light led into the main body 20 propagates in the Pd direction toward the opposite end 26. During this, the light may be reflected on the front surface 24 and/or the rear surface 23 of the light guide. When the light meets the rear surface 23 at an angle smaller than the critical angle, the light will not be reflected on the rear surface 23, but pass through to enter the LCD panel 1. This happens everywhere on the rear surface 23, whereby the light will be emitted uniformly from the rear surface 23.

The thus emitted light is filtered by the first polarizer 13a, so that only horizontally (or vertically) oscillating light is allowed to pass through. Then, the light is rotated through 90° by the liquid crystal 12, thereby becoming vertically (or horizontally) oscillating light. This light can pass through the second polarizer 13b and is reflected forward by the mirror 14. Then, the light passes through the second polarizer 13b again, and is rotated through 9° by the liquid crystal 12 to become horizontally (or vertically) oscillating light again. Then, the light passes through the first polarizer 13a and the main body 20 of the light guide 2, to be emitted forward from the LCD X1.

For displaying the desired information, an electric field is applied to the appropriate pixels (the intersections of transparent electrodes 15a, 15b). As a result, no light is transmitted as the molecular alignment of the liquid crystal 12 is changed by the field, which causes the monitor to appear black at the selected points.

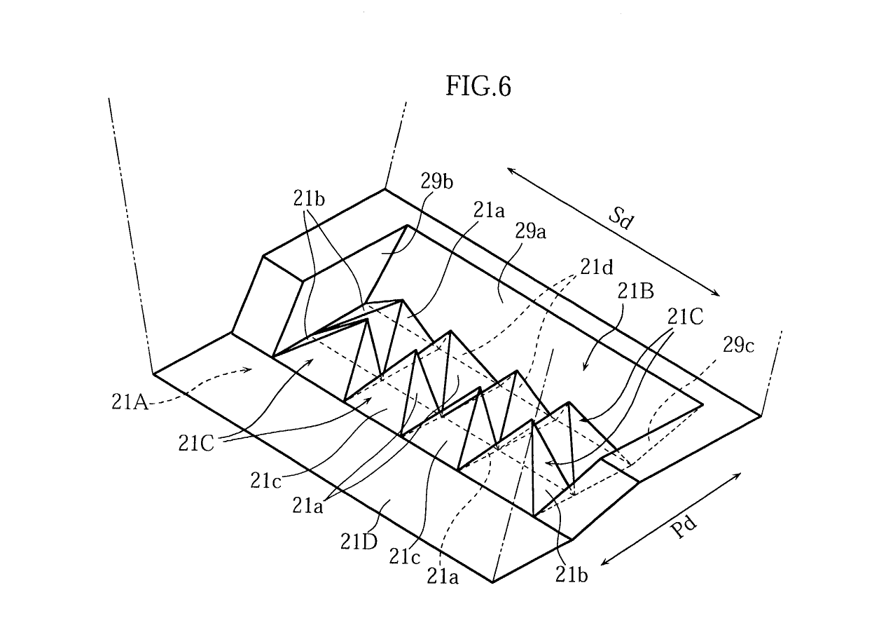

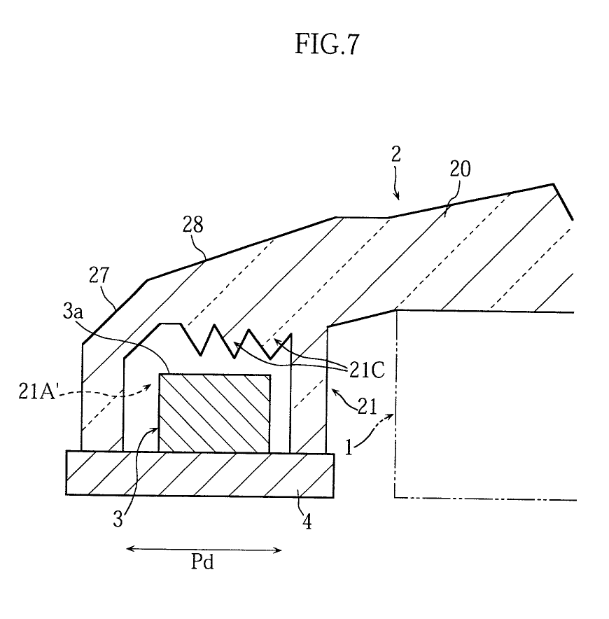

In the embodiment described above, the recess 21A for accommodating the light source 3 extends through the light inlet portion 21 in the Pd direction, as shown in FIG. 5. According to the present invention, however, the recess may not be formed in this manner. For instance, as shown in FIG. 7, the light inlet portion 21 may be formed with a recess 21A′ which is open only downward to allow the insertion of the light source 3.

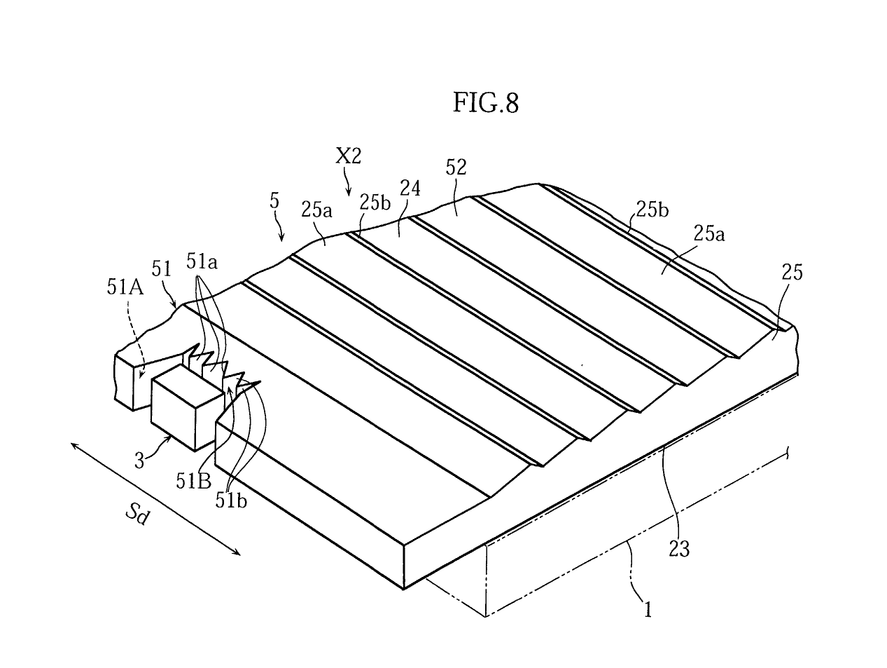

FIG. 8 shows the principal portions of an LCD X2 according to a second embodiment of the present invention. As shown, the LCD X2 includes a light guide 5 which is substantially planar, as opposed to the previous light guide 2 having an L-shaped cross section (see FIG. 1). The light guide 5 is provided with a light inlet portion 51 and a main body 52. The main body 52 covers the front surface of the LCD panel 1, while the light inlet portion 51 protrudes sideways from the panel 1. The light source 3 is accommodated in a recess 51A formed in the light inlet portion 51. In the recess 51A, two kinds of light refracting surfaces 51a and 51b are provided for causing the light emitted from the light source 3 to propagate longitudinally of the light inlet portion 51 (i.e., in the Sd direction).

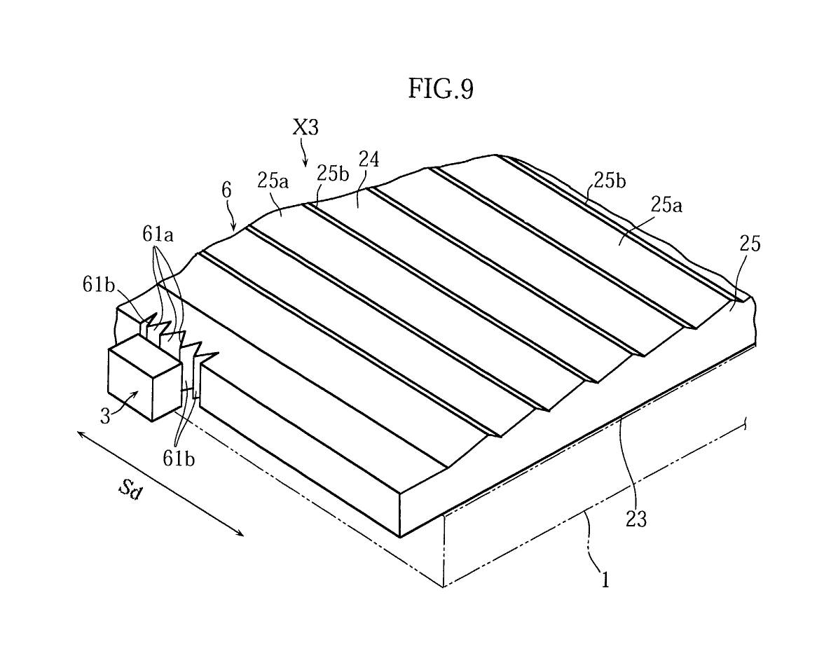

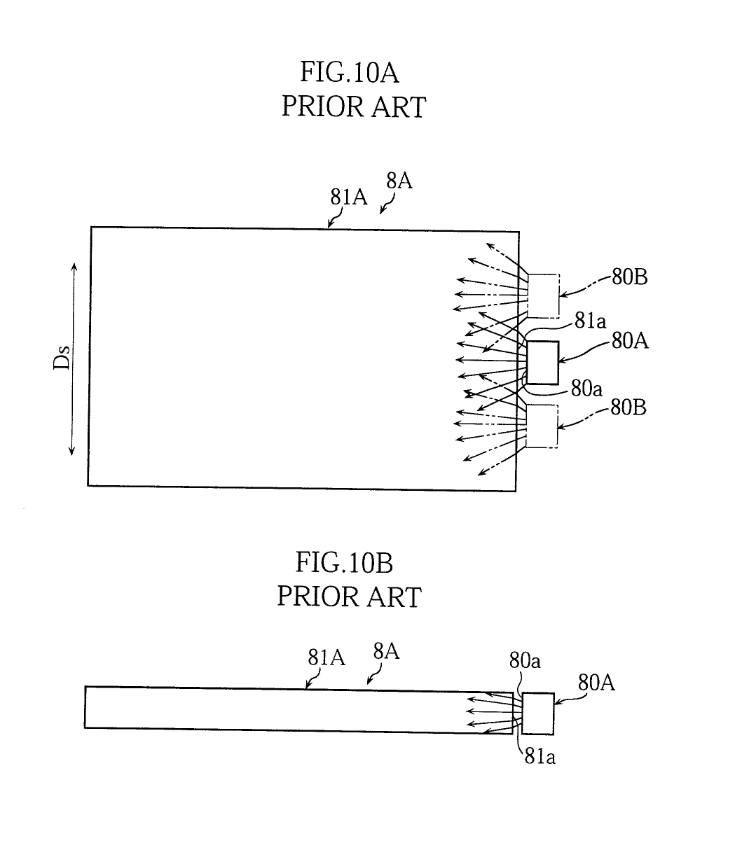

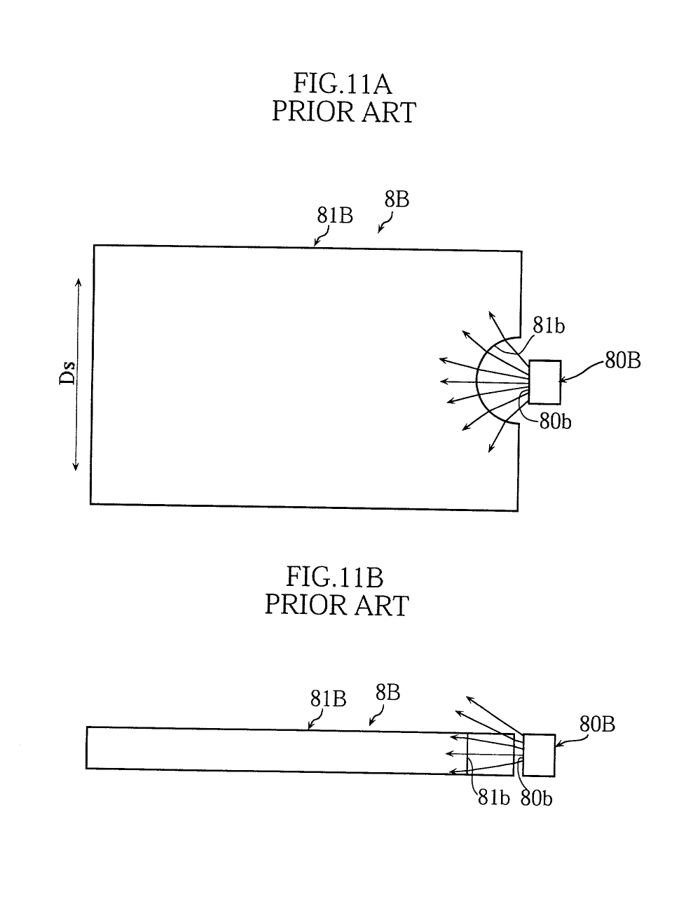

FIG. 9 shows the principal portions of an LCD X3 according to a third embodiment of the present invention. The LCD X3 is basically similar to the LCD X2 of the second embodiment (see FIG. 8), except that the light guide 6 is provided with no recess to accommodate the light source 3. The light source 3, arranged outside of the light guide 6, faces two kinds of light refracting surfaces 61a and 61b.

The present invention being thus described, it is obvious that the same may be varied in many ways. Such variations are not to be regarded as a departure from the spirit and scope of the present invention, and all such modifications as would be obvious to those skilled in the art are intended to be included within the scope of the following claims.

1. A lighting unit comprising:
a light guide provided with a light inlet section; and
a light source provided with a light emitting surface facing the light inlet section;
wherein the light guide is provided, at the light inlet section, with a plurality of light refracting surfaces inclined relative to the light emitting surface so that light from the light source is distributed in the light guide.

2. The lighting unit according to claim 1, wherein the light refracting surfaces comprise a plurality of first slopes which are symmetrical with respect to a predetermined reference line, the first slopes being steeper relative to the light emitting surface as they are farther from the reference line.

3. The lighting unit according to claim 2, wherein the light refracting surfaces comprise a plurality of second slopes which are symmetrical with respect to the reference line, the second slopes being gentler relative to the light emitting surface as they are farther from the reference line.

4. The lighting unit according to claim 3, wherein the light refracting surfaces comprises a plurality of additional slopes different from the first and the second slopes, the additional slopes together with the first and the second slopes being arranged to define a plurality of pyramids.

5. The lighting unit according to claim 4, wherein the pyramids are arranged in rows and columns.

6. The lighting unit according to claim 4, wherein the pyramids are provided with apexes lying on a plane parallel to the light emitting surface.

7. The lighting unit according to claim 4, wherein the light inlet section is provided with a light refracting wall surf ace adjacent to the pyramids.

8. The lighting unit according to claim 7, wherein the light inlet -section is provided with a flat surface which is arranged adjacent to the pyramids and generally parallel to the light emitting surface.

9. The lighting unit according to claim 1, wherein the light guide is provided with a main portion covering an object to be illuminated and with an elongated auxiliary portion connected to the main portion, the light refracting surfaces being provided at the auxiliary portion.

10. The lighting unit according to claim 9, wherein the auxiliary portion is formed with a recess for accommodating the light source.

11. The lighting unit according to claim 10, wherein the main portion includes a generally flat rear surface and a front surface opposite to the rear surface, the auxiliary portion projecting beyond the rear surface of the main portion away from the front surface of the main portion.

12. The lighting unit according to claim 11, wherein the recess is open only in the projecting direction of the auxiliary portion.

13. The lighting unit according to claim 11, wherein the light guide is provided with a reflective surface for directing light from the auxiliary portion to the main portion.

14. A liquid crystal display comprising:
a liquid crystal display panel;
a light guide provided with a light inlet section; and
a light source provided with a light emitting surface facing the light inlet section;
wherein the light guide is provided, at the light inlet section, with a plurality of light refracting surfaces inclined relative to the light emitting surface so that light from the light source is distributed in the light guide.
